(19) United States
(12) Patent Application Publication
(10) Pub. No.: US 2025/0300269 A1
(43) Pub. Date: Sep. 25, 2025

(54) BATTERY TEMPERATURE CONTROL SYSTEM

(71) Applicant: HONDA MOTOR CO., LTD., Tokyo (JP)

(72) Inventors: Daichi WATANABE, Saitama (JP); Takahiro Yasue, Saitama (JP); Nobuyuki Akaishi, Saitama (JP)

(73) Assignee: HONDA MOTOR CO., LTD., Tokyo (JP)

(21) Appl. No.: 19/064,722

(22) Filed: Feb. 27, 2025

(30) Foreign Application Priority Data
Mar. 25, 2024 (JP) 2024-048256

(51) Int. Cl. H01M 10/65; H01M 10/48; H01M 10/613; H01M 10/615

(52) U.S. Cl. CPC H01M 10/65; H01M 10/486; H01M 10/613; H01M 10/615

(57) ABSTRACT

A battery temperature control system includes: a battery; a cooling unit configured to cool the battery; a heating unit configured to heat the battery; a temperature acquisition unit configured to acquire a temperature of the battery; and a temperature control unit configured to control the cooling unit and the heating unit, the temperature control unit is configured to be capable of switching between a cooling state, a heating state, and a stopped state, and the temperature control unit is configured to switch between the cooling state and the heating state at least once when the temperature of the battery approaches a target temperature.

### CROSS-REFERENCE TO RELATED APPLICATION

This application is based on and claims priority under 35 USC 119 from Japanese Patent Application No. 2024-048256 filed on Mar. 25, 2024.

### TECHNICAL FIELD

The present invention relates to a battery temperature control system.

### BACKGROUND ART

In recent years, efforts to realize a low-carbon society or a decarbonized society become active, and research and development about an electrification technique are conducted to reduce CO₂ emission and improve energy efficiency in vehicles.

In the electrification technique, a battery plays an important role, and from the viewpoint of preventing output limitation of the battery and preventing deterioration of the battery, temperature control of the battery is performed so that a temperature of the battery is maintained within a desired temperature region.

For example, Patent Literature 1 discloses a system that estimates a maximum temperature inside a cell in a battery module including a plurality of cells, and controls a charging/discharging current of the battery module or cooling of the battery module such that the estimated maximum temperature does not exceed an upper limit temperature during charging/discharging of the battery module.

### PATENT LITERATURE

Patent Literature 1: WO2019/244489

### SUMMARY OF INVENTION

However, when the battery module is cooled such that the maximum temperature does not exceed the upper limit temperature, a minimum temperature of the battery module may become too low and an output of the battery may be limited. Particularly, in recent years, a high-capacity laminated cell has a large electrode body area, and tends to have a large temperature distribution in the cell during cooling, heating, application of a large current, and the like.

The present invention provides a battery temperature control system capable of bringing a temperature of a battery close to a target temperature while eliminating a temperature difference inside the battery.

The present invention provides a battery temperature control system, the battery temperature control system including:
a battery;
a cooling unit configured to cool the battery;
a heating unit configured to heat the battery;
a temperature acquisition unit configured to acquire a temperature of the battery; and
a temperature control unit configured to control the cooling unit and the heating unit, in which
the temperature control unit is configured to be capable of switching between
   a cooling state in which the cooling unit is in an operating state and the heating unit is in a non-operating state,
   a heating state in which the cooling unit is in the non-operating state and the heating unit is in the operating state, and
   a stopped state in which the cooling unit is in the non-operating state and the heating unit is in the non-operating state, and
the temperature control unit is configured to switch between the cooling state and the heating state at least once when the temperature of the battery approaches a target temperature.

According to the present invention, it is possible to bring the temperature of the battery close to the target temperature while eliminating a temperature difference inside the battery. Accordingly, it is possible to prevent the output of the battery from being limited due to a localized decrease in the temperature of the battery, or prevent the battery from deteriorating due to a localized increase in the temperature of the battery.

### BRIEF DESCRIPTION OF DRAWINGS

FIG. 1 is a block diagram of a battery temperature control system 1 according to an embodiment of the present invention.

FIG. 2 is a schematic diagram illustrating a temperature inside a battery 3.

FIG. 3 shows, in a cooling mode for cooling a battery of a conventional battery temperature control system, (a) a graph of a temperature inside the battery and (b) a graph of an allowable output of the battery.

FIG. 4 shows, in a cooling mode for cooling the battery 3 of the battery temperature control system 1 of the present embodiment, (a) a graph of a temperature inside the battery, (b) a graph of a water temperature, and (c) a graph of an allowable output of the battery.

FIG. 5 shows a graph of the temperature inside the battery, a graph of the allowable output of the battery, and a graph of the water temperature in the cooling mode in which the battery temperature control system 1 cools the battery 3, more specifically, in each of three modes including (a) a cooling priority mode, (b) a normal cooling mode, and (c) an output priority mode.

FIG. 6 is a flowchart (part 1) showing a procedure for executing the cooling mode described in FIG. 5.

FIG. 7 is a flowchart (part 2) showing the procedure for executing the cooling mode described in FIG. 5.

FIG. 8 shows a graph of the temperature inside the battery in a heating mode for heating the battery of the conventional battery temperature control system.

FIG. 9 shows (a) a graph of the temperature inside the battery and (b) a graph of the water temperature in a heating mode for heating the battery 3 of the battery temperature control system 1 in the present embodiment.

FIG. 10 shows a graph of the temperature inside the battery and a graph of the water temperature in the heating mode in which the battery temperature control system 1 heats the battery 3, more specifically, in each of two modes including (a) a heating priority mode and (b) an active protection mode.

FIG. 11 is a flowchart showing a procedure for executing the heating mode described in FIG. 10.

### DETAILED DESCRIPTION OF THE INVENTION

Hereinafter, a battery temperature control system according to an embodiment of the present invention will be described with reference to the accompanying drawings.

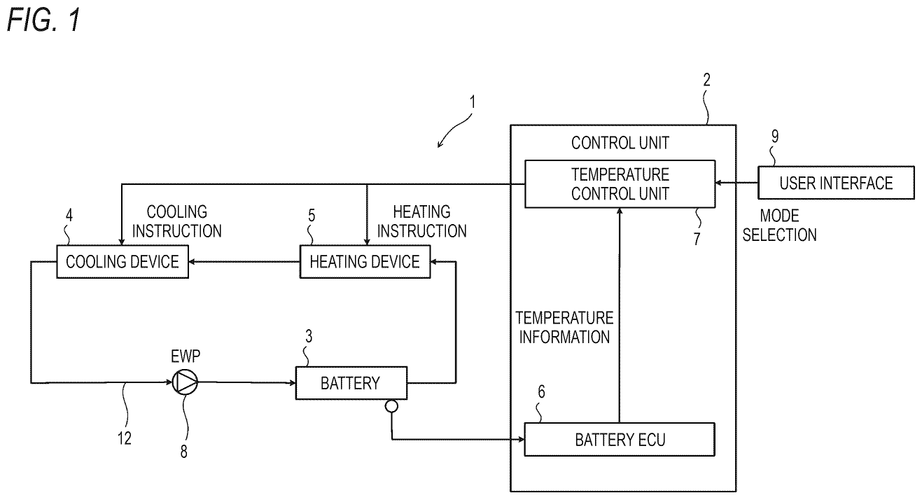

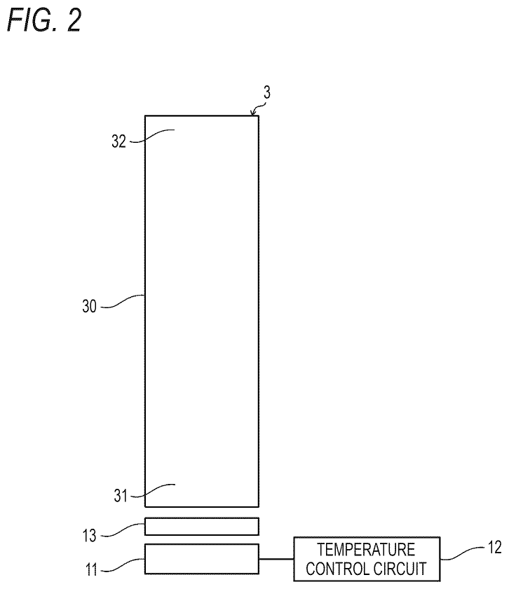

FIG. 1 is a block diagram of a battery temperature control system 1 according to an embodiment of the present invention. The battery temperature control system 1 includes a control unit 2, a battery 3, a cooling device 4, a heating device 5, an electric water pump (EWP) 8, and a user interface 9. The battery temperature control system 1 is a system that is provided in, for example, a vehicle driven by power and executes temperature adjustment of a battery that is a power source. The battery 3, the cooling device 4, the heating device 5, and the EWP 8 are disposed in a temperature control circuit 12 that allows a refrigerant to circulate. Inside the battery 3, a water jacket 11 (see FIG. 2) connected to the temperature control circuit 12 is configured to be in direct or indirect contact with one surface of the battery 3 to exchange heat with the battery 3.

The control unit 2 is a computer that includes, for example, a processor configured to perform various calculations, a storage unit having a non-transitory storage medium for storing various types of information, and an input and output unit configured to control input and output of data between an inside and an outside of the control unit 2 (none of which is illustrated), and executes overall control of the battery temperature control system 1. The control unit 2 includes a battery electronic control unit (ECU) 6 and a temperature control unit 7.

The battery 3 includes a plurality of cells and supplies power for driving the vehicle. The cell is, for example, a laminated cell made of a solid-state battery. The laminated cell includes a positive electrode to which a positive electrode tab is connected, a negative electrode to which a negative electrode tab is connected, a solid electrolyte disposed between the positive electrode and the negative electrode, and a laminated film that accommodates the positive electrode, the negative electrode, and the solid electrolyte, and the laminated cell performs charging and discharging by transferring lithium ions between the positive electrode and the negative electrode via the solid electrolyte. The cooling device 4 functions as a cooling unit that cools the battery 3 to prevent a temperature increase of the battery 3. The heating device 5 functions as a heating unit that heats the battery 3 to prevent an output of the battery from being limited. The EWP 8 is an electric water pump, and is a device that allows a refrigerant to circulate while allows the refrigerant to flow around the battery 3. The user interface 9 is an interface device including a switch, a button, a touch panel, and the like that allows a user (for example, a driver of a vehicle) to perform an operation input of the battery temperature control system 1.

The battery ECU 6 of the control unit 2 functions as a temperature acquisition unit that acquires a temperature of the battery 3 as described later. Further, the battery ECU 6 can also function as an output control unit that controls the output of the battery 3. The temperature control unit 7 receives temperature information of the battery 3 from the battery ECU 6, and controls the cooling device 4 and the heating device 5 to control the temperature of the battery 3.

FIG. 2 is a schematic diagram illustrating a temperature inside the battery 3, and specifically, a diagram illustrating a temperature distribution of each cell constituting the battery 3. In the present embodiment, the water jacket 11 connected to the temperature control circuit 12 is in indirect contact with a lower surface of the battery 3 (the cell) via a heat transfer material 13.

Assuming that the battery 3 is cooled, when a refrigerant circulates through the water jacket 11, a temperature of a battery lower region (a cell lower region) 31 close to the water jacket 11 is likely to decrease, but a temperature of a battery upper region (a cell upper region) 32 far from the water jacket 11 is unlikely to decrease, resulting in a temperature distribution in the battery. From such a viewpoint, the battery ECU 6 acquires at least a temperature of one side (a lower side in the figure) of the battery 3 and a temperature of a side (an upper side in the figure) opposite to the one side, and performs temperature control in consideration of the temperature distribution in the battery.

In addition, the battery ECU 6 determines allowable power with reference to a minimum temperature of the battery 3 during normal use, and therefore, as the temperature distribution occurs in the battery, usable power is limited, and it is difficult to use up battery performance.

When the battery 3 is cooled such that the maximum temperature does not exceed an upper limit temperature, the minimum temperature of the battery 3 may become too low and the output of the battery 3 may be limited. Particularly, a high-capacity laminated cell that has been introduced in recent years has a large electrode body area, and tends to have a large temperature distribution in the battery during cooling, heating, application of a large current, and the like. In the case of an all-solid-state battery, the temperature distribution in the battery tends to become larger due to the characteristic that an upper limit temperature for use thereof is high. In order to efficiently use up the battery, it is necessary to reduce the temperature distribution.

Therefore, in the present embodiment, the temperature control unit 7 can switch between a cooling state in which the cooling device 4 is in an operating state and the heating device 5 is in a non-operating state, a heating state in which the cooling device 4 is in the non-operating state and the heating device 5 is in the operating state, and a stopped state in which the cooling device 4 is in the non-operating state and the heating device 5 is in the non-operating state. When the temperature of the battery 3 approaches a target temperature, the temperature control unit 7 switches between the cooling state and the heating state at least once, preferably a plurality of times. Hereinafter, a specific aspect of the control will be described.

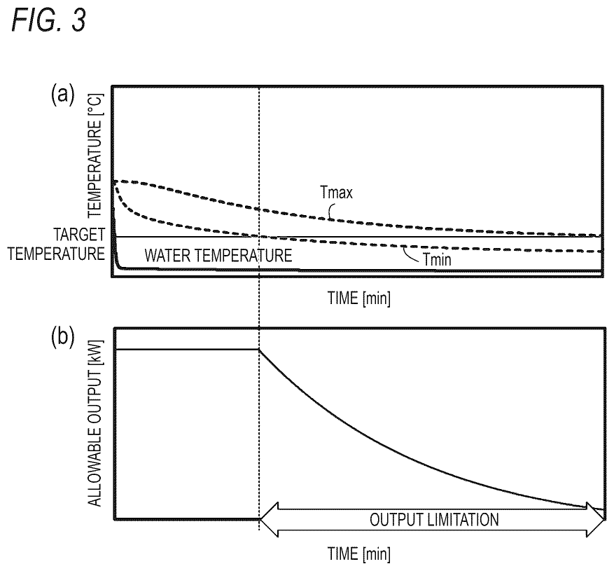

FIG. 3 shows, in a cooling mode for cooling a battery of a conventional battery temperature control system, (a) a graph of a temperature inside the battery and (b) a graph of an allowable output. Further, (a) of FIG. 3 shows time variations of a water temperature (a temperature of a refrigerant), a minimum temperature Tmin inside the battery, and a maximum temperature Tmax inside the battery with respect to a target temperature of the battery 3 which is a constant control target. The maximum temperature Tmax inside the battery, which is the temperature in a vicinity of the battery upper region 32, exceeds the target temperature even over time. On the other hand, the minimum temperature Tmin inside the battery, which is a temperature in a vicinity of the battery lower region 31, falls below the target temperature over time.

When the battery ECU 6 acquires the minimum temperature Tmin inside the battery and the maximum temperature Tmax inside the battery of the battery 3, the battery ECU 6 determines the allowable power of the battery 3 with reference to the minimum temperature Tmin inside the battery. Thus, as shown in (b) of FIG. 3, when the minimum temperature Tmin inside the battery falls below the target temperature, the battery ECU 6 limits the allowable output of the battery 3, and thus the usable power is limited.

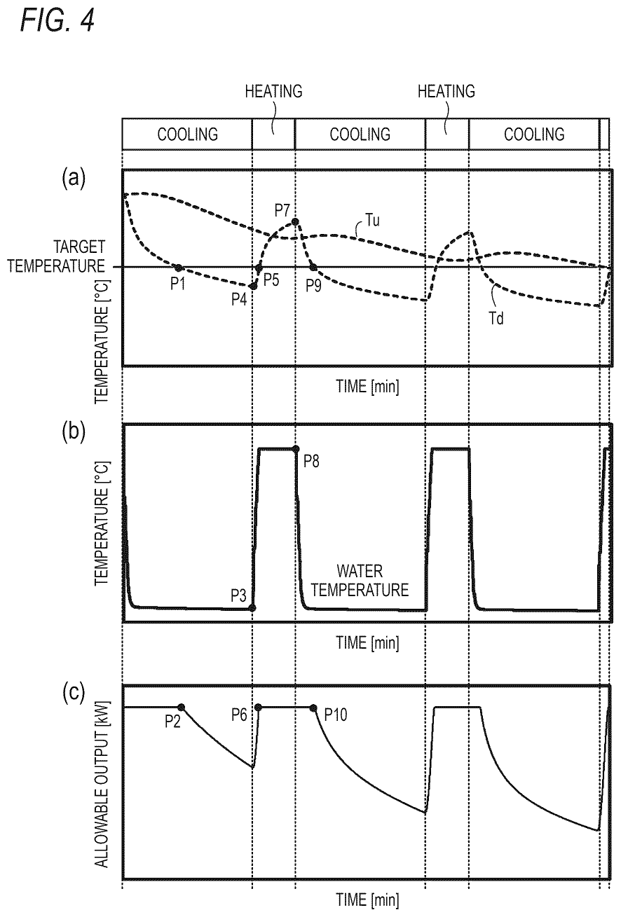

Further, FIG. 4 shows, in a cooling mode for cooling the battery 3 of the battery temperature control system 1 of the present embodiment, (a) a graph of a temperature inside the battery, (b) a graph of a water temperature, and (c) a graph of an allowable output.

The battery ECU 6 acquires a battery lower portion temperature Td of the battery lower region 31 and a battery upper portion temperature Tu of the battery upper region 32, and calculates the maximum temperature Tmax inside the battery and the minimum temperature Tmin inside the battery. A method for calculating the maximum temperature Tmax inside the battery and the minimum temperature Tmin inside the battery is not particularly limited. Among temperatures measured at a plurality of points, a maximum temperature may be set as the maximum temperature Tmax inside the battery, and a minimum temperature may be set as the minimum temperature Tmin inside the battery. An average of temperatures at a plurality of points on a higher temperature side may be set as the maximum temperature Tmax inside the battery, and an average of temperatures at a plurality of points on a lower temperature side may be set as the minimum temperature Tmin inside the battery. The maximum temperature Tmax inside the battery and the minimum temperature Tmin inside the battery may be calculated from a predetermined formula based on the battery upper portion temperature and the battery lower portion temperature.

The temperature control unit 7 refers to the minimum temperature Tmin inside the battery and the maximum temperature Tmax inside the battery of the battery 3, and switches between the cooling state, the heating state, and the stopped state as described above.

When cooling the battery 3, the temperature control unit 7 selects the cooling state in which the cooling device 4 is in the operating state and the heating device 5 is in the non-operating state. In the cooling state, the battery lower portion temperature Td (the minimum temperature Tmin inside the battery) and the battery upper portion temperature Tu (the maximum temperature Tmax inside the battery) decrease. As shown in (a) of FIG. 4, when the battery lower portion temperature Td (the minimum temperature Tmin inside the battery) falls below the target temperature (P1), the battery ECU 6 limits the allowable output of the battery 3 as shown in (c) of FIG. 4 (P2).

When a predetermined time elapses as the battery upper portion temperature Tu (the maximum temperature Tmax inside the battery) decreases, the temperature control unit 7 selects the heating state in which the cooling device 4 is in the non-operating state and the heating device 5 is in the operating state. Accordingly, as shown in (b) of FIG. 4, the water temperature starts to rise (P3), and the minimum temperature Tmin inside the battery starts to rise as the battery lower portion temperature Td of the battery lower region 31 close to the water jacket 11 increases (P4). When the battery lower portion temperature Td (the minimum temperature Tmin inside the battery) exceeds the target temperature (P5), the battery ECU 6 removes the limitation on the allowable output of the battery 3 (P6).

When the predetermined time elapses in the heating state, the battery lower portion temperature Td greatly exceeds the target temperature (P7). Then, the temperature control unit 7 shifts to the cooling state in which the cooling device 4 is in the operating state and the heating device 5 is in the non-operating state. Accordingly, as shown in (b) of FIG. 4, the water temperature starts to decrease (P8), and the battery lower portion temperature Td decreases. When the battery lower portion temperature Td (the minimum temperature Tmin inside the battery) falls below the target temperature (P9), the battery ECU 6 limits the allowable output of the battery 3 as shown in (c) of FIG. 4 (P10).

In this way, in an environment in which the output of the battery 3 is controlled based on the minimum temperature Tmin inside the battery of the battery 3, by bringing the temperature of the battery 3 close to the target temperature while eliminating a temperature difference inside the battery 3, it is possible to prevent the temperature of the battery 3 from being locally decreased and the output of the battery 3 from being limited.

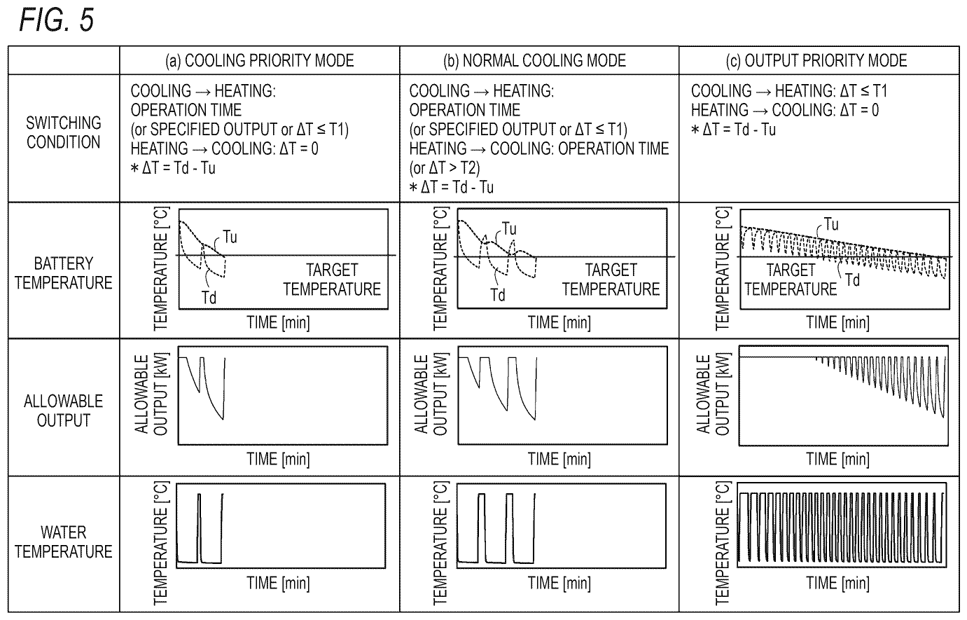

FIG. 5 shows a graph of the temperature inside the battery, a graph of the allowable output, and a graph of the water temperature in the cooling mode in which the battery temperature control system 1 cools the battery 3, more specifically, in each of three modes including (a) a cooling priority mode, (b) a normal cooling mode, and (c) an output priority mode.

In the cooling priority mode of (a) of FIG. 5, the cooling state is switched to the heating state at the following timings, for example.
Timing when an operation time of the cooling device 4 exceeds the predetermined time
Timing when the allowable output of the battery 3 reaches a predetermined specified output (or less)
Timing when a temperature difference ΔT (ΔT=Td−Tu, the same applies hereinafter) obtained by subtracting the battery upper portion temperature Tu from the battery lower portion temperature Td is equal to or smaller than a predetermined allowable temperature difference T1 during cooling (ΔT≤T1)

The heating state is switched to the cooling state at the following timings, for example.
Timing when the temperature difference ΔT is zero (ΔT=0)

According to this mode, the maximum temperature Tmax inside the battery reaches the target temperature in a short time. Thus, it is possible to perform pre-cooling in preparation for short-time quick charging. Meanwhile, an output limit until the maximum temperature Tmax inside the battery reaches the target temperature increases.

In the normal cooling mode of (b) of FIG. 5, the cooling state is switched to the heating state at the following timings, for example.
Timing when the operation time of the cooling device 4 exceeds the predetermined time
Timing when the allowable output reaches the predetermined specified output (or less)
Timing when the temperature difference ΔT is equal to or smaller than the predetermined allowable temperature difference T1 during cooling (ΔT≤T1)

The heating state is switched to the cooling state at the following timings, for example.
Timing when an operation time of the heating device 5 exceeds the predetermined time
Timing when the temperature difference ΔT is larger than a predetermined allowable temperature difference T2 during heating (ΔT>T2)

According to this mode, the maximum temperature Tmax inside the battery reaches the target temperature over an appropriate time. The output limit is limited to a certain degree until the maximum temperature Tmax inside the battery reaches the target temperature.

In the output priority mode of (c) of FIG. 5, the cooling state is switched to the heating state at the following timings, for example.
Timing when the temperature difference ΔT is equal to or smaller than the predetermined allowable temperature difference T1 during cooling (ΔT≤T1)

The heating state is switched to the cooling state at the following timings, for example.
Timing when the temperature difference ΔT is zero (ΔT=0)

According to this mode, it is possible to minimize a region where the output of the battery 3 is limited, and it is possible to apply this mode in a situation where cooling is necessary while securing a constant output, such as during normal driving. The time until the maximum temperature Tmax inside the battery reaches the target temperature becomes long.

In the present embodiment, the battery ECU 6 acquires temperatures of a plurality of locations in the battery 3 in order to acquire the minimum temperature Tmin inside the battery and the maximum temperature Tmax inside the battery. The temperature control unit 7 can switch between the cooling state and the heating state based on the temperature difference ΔT between a higher-temperature side temperature such as the maximum temperature Tmax inside the battery and a lower-temperature side temperature such as the minimum temperature Tmin inside the battery. Accordingly, it is possible to prevent the temperature difference between the higher-temperature side temperature and the lower-temperature side temperature of the battery 3 from increasing by a predetermined value or more.

The switching between the cooling state and the heating state by the temperature control unit 7 may be performed based on the operation time of the cooling device 4 or the heating device 5. Accordingly, it is possible to easily perform the control while preventing the temperature difference between the higher-temperature side temperature and the lower-temperature side temperature of the battery 3 from increasing by a predetermined value or more.

Further, the temperature control unit 7 is configured to be able to control the temperature of the battery 3 in a plurality of modes in which conditions for switching between the cooling state and the heating state are different, but the plurality of modes may be set in response to, for example, a user request input from the user interface 9. Accordingly, the user request can be reflected in the temperature control of the battery 3.

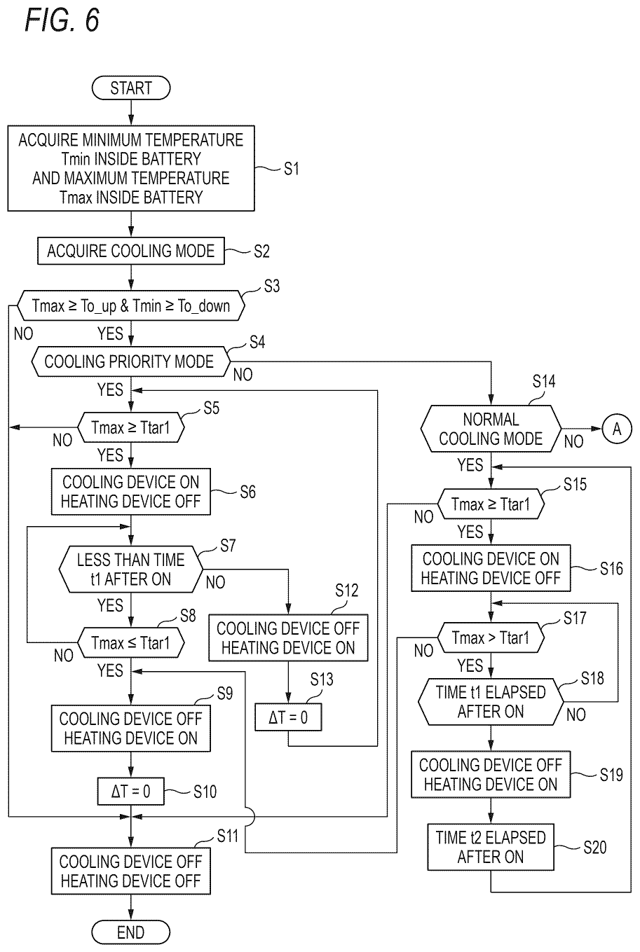

FIG. 6 is a flowchart (part 1) showing a procedure for executing the cooling mode described in FIG. 5. First, the battery ECU 6 acquires the minimum temperature Tmin inside the battery and the maximum temperature Tmax inside the battery (step S1). Subsequently, the cooling mode set in response to the operation of the user interface 9 by the user is acquired (step S2)

Next, the temperature control unit 7 compares the following four values.
Minimum temperature Tmin inside the battery
Maximum temperature Tmax inside the battery
Cooling device operation permitted battery upper limit temperature To_up at which the operation of the cooling device 4 is permitted
Cooling device operation permitted battery lower limit temperature To_down at which the operation of the cooling device 4 is permitted

The temperature control unit 7 determines whether the maximum temperature Tmax inside the battery is equal to or higher than the cooling device operation permitted battery upper limit temperature To_up and the minimum temperature Tmin inside the battery is equal to or higher than the cooling device operation permitted battery lower limit temperature To_down (step S3). That is, the temperature control unit 7 determines whether the following formula (1) is satisfied.

$$T max \geq To\_up and T min \geq To\_down \qquad ( 1 )$$

If the condition of the formula (1) is satisfied (step S3; Yes), the temperature control unit 7 determines whether the set cooling mode is the cooling priority mode shown in (a) of FIG. 5 (step S4). If the set cooling mode is the cooling priority mode (step S4; Yes), the temperature control unit 7 determines whether the maximum temperature Tmax inside the battery is equal to or higher than a cooling target temperature Ttar1 which is a temperature to be targeted in the cooling mode (step S5).

If the maximum temperature Tmax inside the battery is equal to or higher than the cooling target temperature Ttar1 (Tmax>Ttar1) (step S5; Yes), the temperature control unit 7 sets a cooling state in which the cooling device 4 is turned on (the operating state) and the heating device 5 is turned off (the non-operating state) (step S6).

After the cooling device 4 is turned on, the temperature control unit 7 counts an operating time of the cooling device 4 and determines whether the operating time is less than a cooling device operating time t1 (step S7). If the operating time is less than the cooling device operating time t1 (step S7; Yes), the temperature control unit 7 determines whether the maximum temperature Tmax inside the battery is equal to or lower than the cooling target temperature Ttar1 (Tmax≤Ttar1) (step S8).

If the maximum temperature Tmax inside the battery is equal to or lower than the cooling target temperature Ttar1 (Tmax≤Ttar1) (step S8; Yes), the temperature control unit 7 sets a heating state in which the cooling device 4 is turned off (the non-operating state) and the heating device 5 is turned on (the operating state) (step S9). In step S8, if the maximum temperature Tmax inside the battery is not equal to or lower than the cooling target temperature Ttar1 (step S8; No), the process returns to step S7 again, and the temperature control unit 7 counts the operating time of the cooling device 4.

If the temperature difference ΔT obtained by subtracting the battery upper portion temperature Tu from the battery lower portion temperature Td becomes zero (step S10), the temperature control unit 7 sets a stopped state in which the cooling device 4 is turned off (the non-operating state) and the heating device 5 is turned off (the non-operating state) (step S11), and ends the processing.

In step S7, if the operating time of the cooling device 4 is equal to or longer than the cooling device operating time t1 (step S7; No), the temperature control unit 7 sets a heating state in which the cooling device 4 is turned off (the non-operating state) and the heating device 5 is turned on (the operating state) (step S12).

If the temperature difference ΔT obtained by subtracting the battery upper portion temperature Tu from the battery lower portion temperature Td becomes zero (step S13), the process returns to step S5 again, and the processing subsequent to step S5 is repeated.

If the condition of the formula (1) is not satisfied in step S3 (step S3; No), or if the maximum temperature Tmax inside the battery is lower than the cooling target temperature Ttar1 in step S5 (step S5; No), the process proceeds to step S11, and the temperature control unit 7 sets the stopped state and ends the processing.

Next, the normal cooling mode shown in (b) of FIG. 5 will be described. If it is determined in step S4 that the set cooling mode is not the cooling priority mode (step S4; No), the temperature control unit 7 determines whether the set cooling mode is the normal cooling mode (step S14). If the set cooling mode is the normal cooling mode (step S14; Yes), the temperature control unit 7 determines whether the maximum temperature Tmax inside the battery is equal to or higher than the cooling target temperature Ttar1 which is the temperature to be targeted in the cooling mode (step S15).

If the maximum temperature Tmax inside the battery is equal to or higher than the cooling target temperature Ttar1 (Tmax>Ttar1) (step S15; Yes), the temperature control unit 7 sets the cooling state in which the cooling device 4 is turned on (the operating state) and the heating device 5 is turned off (the non-operating state) (step S16).

Further, the temperature control unit 7 determines whether the maximum temperature Tmax inside the battery is higher than the cooling target temperature Ttar1 (Tmax>Ttar1) (step S17). If the maximum temperature Tmax inside the battery is higher than the cooling target temperature Ttar1 (step S17; Yes), the temperature control unit 7 determines whether the operating time of the cooling device 4 exceeds the cooling device operating time t1 (step S18). If the operating time of the cooling device 4 does not exceed the cooling device operating time t1 (step S18; No), the process returns to step S17 again, and the temperature control unit 7 determines whether the maximum temperature Tmax inside the battery is higher than the cooling target temperature Ttar1.

In step S18, if the operating time of the cooling device 4 exceeds the cooling device operating time t1 (step S18; Yes), the temperature control unit 7 sets the heating state in which the cooling device 4 is turned off (the non-operating state) and the heating device 5 is turned on (the operating state) (step S19).

After the heating device 5 is turned on, if an operating time of the heating device 5 exceeds a heating device operating time t2 (step S20), the process returns to step S15 again, and the processing subsequent to step S15 is repeated. However, if the maximum temperature Tmax inside the battery is lower than the cooling target temperature Ttar1 in step S15 (step S15; No), the temperature control unit 7 proceeds to step S11, and the temperature control unit 7 sets the stopped state and ends the processing. If the maximum temperature Tmax inside the battery is equal to or lower than the cooling target temperature Ttar1 in step S17 (step S17; No), the temperature control unit 7 proceeds to step S9 and performs the processing subsequent to step S9.

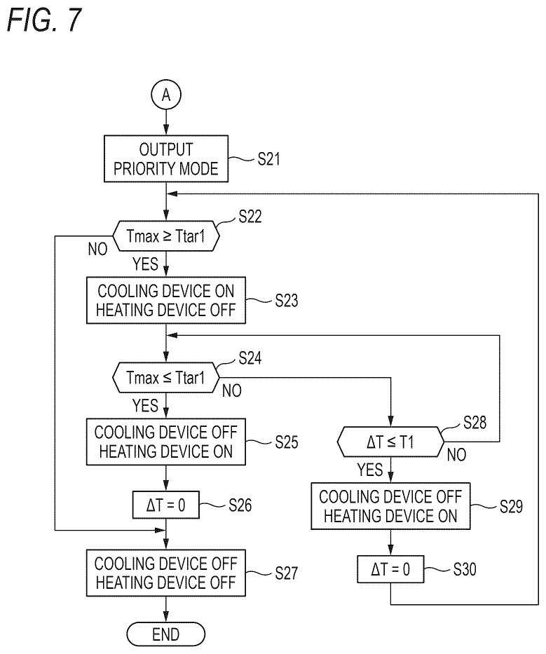

Next, the output priority mode shown in (c) of FIG. 5 will be described with reference to FIG. 7, which is a continuation of FIG. 6. If it is determined in step S14 that the set cooling mode is not the normal cooling mode (step S14; No), the temperature control unit 7 determines that the set cooling mode is the output priority mode (step S21).

The temperature control unit 7 determines whether the maximum temperature Tmax inside the battery is equal to or higher than the cooling target temperature Ttar1 (Tmax>Ttar1) (step S22; Yes). If the maximum temperature Tmax inside the battery is equal to or higher than the cooling target temperature Ttar1 (Tmax>Ttar1) (step S22; Yes), the temperature control unit 7 sets the cooling state in which the cooling device 4 is turned on (the operating state) and the heating device 5 is turned off (the non-operating state) (step S23).

Next, the temperature control unit 7 determines whether the maximum temperature Tmax inside the battery is equal to or lower than the cooling target temperature Ttar1 (step S24). If the maximum temperature Tmax inside the battery is equal to or lower than the cooling target temperature Ttar1 (Tmax≤Ttar1) (step S24; Yes), the temperature control unit 7 sets the heating state in which the cooling device 4 is turned off (the non-operating state) and the heating device 5 is turned on (the operating state) (step S25).

If the temperature difference ΔT obtained by subtracting the battery upper portion temperature Tu from the battery lower portion temperature Td becomes zero (step S26), the temperature control unit 7 sets a stopped state in which the cooling device 4 is turned off (the non-operating state) and the heating device 5 is turned off (the non-operating state) (step S27), and ends the processing. If the maximum temperature Tmax inside the battery is lower than the cooling target temperature Ttar1 in step S22 (step S22; No), the process proceeds to step S27, and the temperature control unit 7 sets the stopped state and ends the processing.

If the maximum temperature Tmax inside the battery is not equal to or lower than the cooling target temperature Ttar1 in step S24 (step S24; No), the temperature control unit 7 determines whether the temperature difference ΔT obtained by subtracting the battery upper portion temperature Tu from the battery lower portion temperature Td is equal to or smaller than the predetermined allowable temperature difference T1 during cooling (step S28). If the temperature difference ΔT is equal to or smaller than the allowable temperature difference T1 during cooling (step S28; Yes), the temperature control unit 7 sets the heating state in which the cooling device 4 is turned off (the non-operating state) and the heating device 5 is turned on (the operating state) (step S29). If the temperature difference ΔT obtained by subtracting the battery upper portion temperature Tu from the battery lower portion temperature Td becomes zero (step S30), the process returns to step S22 again, and the temperature control unit 7 repeats the processing subsequent to step S22.

If the temperature difference ΔT is not equal to or smaller than the allowable temperature difference T1 during cooling in step S28 (step S28; No), the process returns to step S24 again, and the temperature control unit 7 determines whether the maximum temperature Tmax inside the battery is equal to or lower than the cooling target temperature Ttar1. As described above, in the cooling mode, when the maximum temperature Tmax inside the battery is higher than the cooling target temperature Ttar1 (steps S5, S15, and S22), the temperature control unit 7 sets the cooling state (steps S6, S16, and S23). Next, when the maximum temperature Tmax inside the battery is equal to or lower than the cooling target temperature Ttar1 in the cooling state (steps S8, S17, and S24), the temperature control unit 7 switches from the cooling state to the heating state (steps S9 and S25). Further, when the temperature difference ΔT obtained by subtracting the battery upper portion temperature Tu from the battery lower portion temperature Td is equal to or smaller than a first predetermined value (ΔT=0 in this example) in the heating state (steps S10 and S26), the temperature control unit 7 switches from the heating state to the stopped state (steps S11 and S27).

In this way, by switching from the cooling state to the heating state when the maximum temperature Tmax inside the battery is equal to or lower than the cooling target temperature Ttar1 during cooling of the battery 3, it is possible to prevent supercooling of a lower temperature region and prevent the output of the battery 3 from being limited.

In the cooling priority mode shown in (a) of FIG. 5, when the operating state of the cooling device 4 exceeds the cooling device operating time t1 before the maximum temperature Tmax inside the battery becomes equal to or lower than the cooling target temperature Ttar1 (step S7), the temperature control unit 7 switches from the cooling state to the heating state (step S12), and when the temperature difference ΔT obtained by subtracting the battery upper portion temperature Tu from the battery lower portion temperature Td is equal to or smaller than the first predetermined value (ΔT=0 in this example) in the heating state (step S13), the temperature control unit 7 switches from the heating state to the cooling state (step S6).

Accordingly, the maximum temperature Tmax inside the battery can reach the cooling target temperature Ttar1 in a short time.

In the normal cooling mode shown in (b) of FIG. 5, when the operating state of the cooling device 4 exceeds the cooling device operating time t1 before the maximum temperature Tmax inside the battery becomes equal to or lower than the cooling target temperature Ttar1 in the cooling state (step S18), the temperature control unit 7 switches from the cooling state to the heating state (step S19), and when the operating state of the heating device 5 exceeds the heating device operating time t2 in the heating state (step S20), the temperature control unit 7 switches from the heating state to the cooling state (step S16).

Accordingly, it is possible to make the maximum temperature Tmax inside the battery reach the cooling target temperature Ttar1 in a longer time than in the cooling priority mode, and it is possible to prevent the output of the battery 3 from being limited.

In the output priority mode shown in (c) of FIG. 5, when the temperature difference ΔT obtained by subtracting the battery upper portion temperature Tu from the battery lower portion temperature Td is equal to or smaller than the allowable temperature difference T1 during cooling in the cooling state (step S28), the temperature control unit 7 switches from the cooling state to the heating state (step S29), and when the temperature difference obtained by subtracting the battery upper portion temperature Tu from the battery lower portion temperature Td is equal to or smaller than the first predetermined value (ΔT=0 in this example) smaller than the allowable temperature difference TI during cooling in the heating state (step S30), the temperature control unit 7 switches from the heating state to the cooling state (step S23).

Accordingly, it is possible to make the maximum temperature Tmax inside the battery reach the cooling target temperature Ttar1 while reducing the region where the output of the battery 3 is limited.

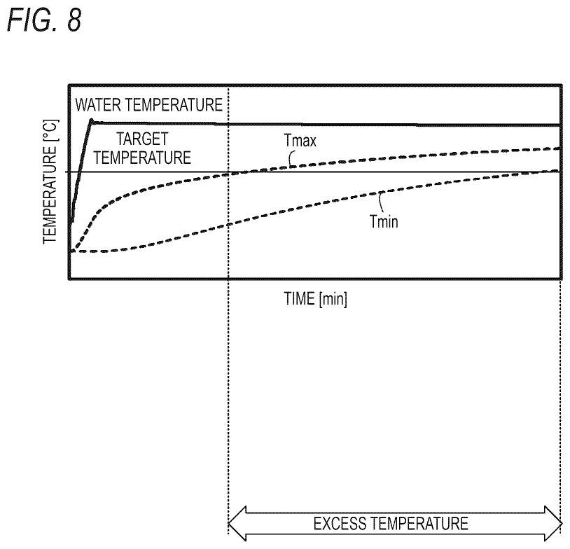

FIG. 8 shows a graph of the temperature inside the battery in a heating mode for heating the battery of the conventional battery temperature control system. FIG. 8 shows time variations of a water temperature (a temperature of a refrigerant), a minimum temperature inside the battery, and a maximum temperature inside the battery with respect to a target temperature of the battery 3 which is a constant control target. The minimum temperature Tmin inside the battery, which is the temperature in the vicinity of the battery upper region 32, approaches the target temperature over time. On the other hand, the maximum temperature Tmax inside the battery, which is the temperature in the vicinity of the battery lower region 31, exceeds the target temperature over time.

When the battery ECU 6 acquires the minimum temperature Tmin inside the battery and the maximum temperature Tmax inside the battery of the battery 3, the battery ECU 6 normally determines the allowable power of the battery 3 with reference to the minimum temperature Tmin inside the battery. The temperature difference inside the battery 3 is not actively eliminated, and when the battery 3 is continuously used thereafter, the maximum temperature Tmax inside the battery is maintained at a high temperature state, and thus there is a concern that local performance deterioration may occur in the battery 3.

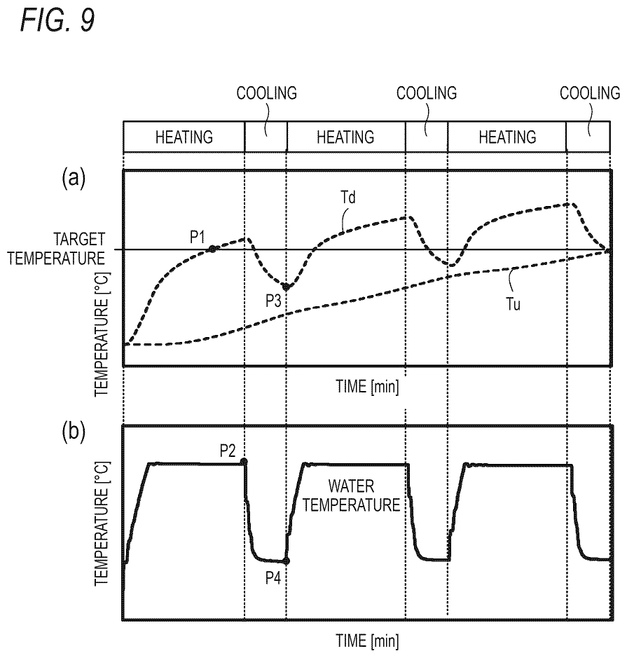

On the other hand, FIG. 9 shows (a) a graph of the temperature inside the battery and (b) a graph of the water temperature (a temperature of a refrigerant) in the heating mode for heating the battery 3 of the battery temperature control system 1 in the present embodiment.

The battery ECU 6 acquires the battery lower portion temperature Td of the battery lower region 31 and the battery upper portion temperature Tu of the battery upper region 32, and calculates the maximum temperature Tmax inside the battery and the minimum temperature Tmin inside the battery. The method for calculating the maximum temperature Tmax inside the battery and the minimum temperature Tmin inside the battery is not particularly limited, and can be calculated in the same manner as during cooling. The temperature control unit 7 refers to the minimum temperature Tmin inside the battery and the maximum temperature Tmax inside the battery of the battery 3, and switches between the cooling state, the heating state, and the stopped state as described above.

When heating the battery 3, the temperature control unit 7 selects the heating state in which the heating device 5 is in the operating state and the cooling device 4 is in the non-operating state. In the heating state, the battery upper portion temperature Tu (the minimum temperature Tmin inside the battery) and the battery lower portion temperature Td (the maximum temperature Tmax inside the battery) increase. As shown in (a) of FIG. 9, after the battery upper portion temperature Tu (the maximum temperature Tmax inside the battery) exceeds the target temperature (P1), the temperature control unit 7 selects the cooling state in which the cooling device 4 is in the operating state and the heating device 5 is in the non-operating state. Accordingly, as shown in (b) of FIG. 9, the water temperature starts to decrease, and the maximum temperature Tmax inside the battery starts to decrease as the battery lower portion temperature Td of the battery lower region 31 close to the water jacket 11 decreases (P2).

When the predetermined time elapses in the cooling state, the battery lower portion temperature Td (the maximum temperature Tmax inside the battery) greatly falls below the target temperature (P3). Then, the temperature control unit 7 shifts to the heating state in which the cooling device 4 is in the non-operating state and the heating device 5 is in the operating state. Accordingly, as shown in (b) of FIG. 9, the water temperature starts to rise (P4), and the battery lower portion temperature Td (the maximum temperature Tmax inside the battery) starts to rise. Thereafter, the temperature control unit 7 and the battery ECU 6 repeat the same operations.

In this way, the temperature control unit 7 can prevent the occurrence of local performance deterioration in the battery 3 by bringing the temperature of the battery 3 close to the target temperature while eliminating the temperature difference inside the battery 3.

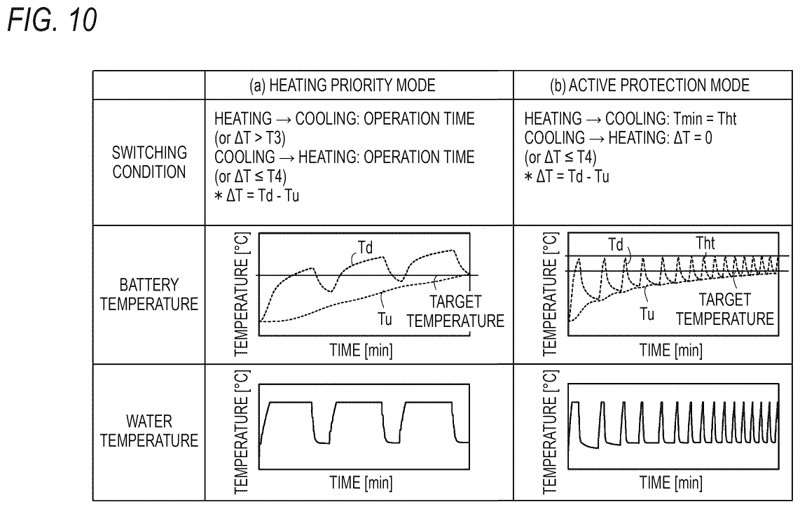

FIG. 10 shows a graph of the temperature inside the battery and a graph of the water temperature in the heating mode in which the battery temperature control system 1 heats the battery 3, more specifically, in each of two modes including (a) a heating priority mode and (b) an active protection mode.

In the heating priority mode of (a) of FIG. 10, the heating state is switched to the cooling state at the following timings, for example.
Timing when the operation time of the heating device 5 exceeds the predetermined time
Timing when the temperature difference ΔT (ΔT=Td−Tu, the same applies hereinafter) obtained by subtracting the battery upper portion temperature Tu from the battery lower portion temperature Td is larger than a predetermined allowable temperature difference T3 during heating (ΔT>T3)

The cooling state is switched to the heating state at the following timings, for example.
Timing when the operation time of the cooling device 4 exceeds the predetermined time
Timing when the temperature difference ΔT is equal to or smaller than a predetermined allowable temperature difference T4 during cooling (ΔT≤T4)

According to this mode, the minimum temperature Tmin inside the battery reaches the target temperature over an appropriate time.

In the active protection mode of (b) of FIG. 10, the heating state is switched to the cooling state at the following timings, for example.
Timing (Tmax=Tht) when the maximum temperature Tmax inside the battery reaches an allowable upper limit temperature Tht during heating, which is an upper limit temperature allowed during heating

The cooling state is switched to the heating state at the following timings, for example.
Timing when the temperature difference ΔT is zero (ΔT=0)
Timing when the temperature difference ΔT is equal to or smaller than the predetermined allowable temperature difference T4 during cooling (ΔT≤T4)

According to this mode, since the maximum temperature Tmax inside the battery does not exceed the allowable upper limit temperature Tht during heating, durability performance of the battery 3 can be maintained for a long period of time. On the other hand, the heating time until the minimum temperature Tmin inside the battery reaches the target temperature becomes long.

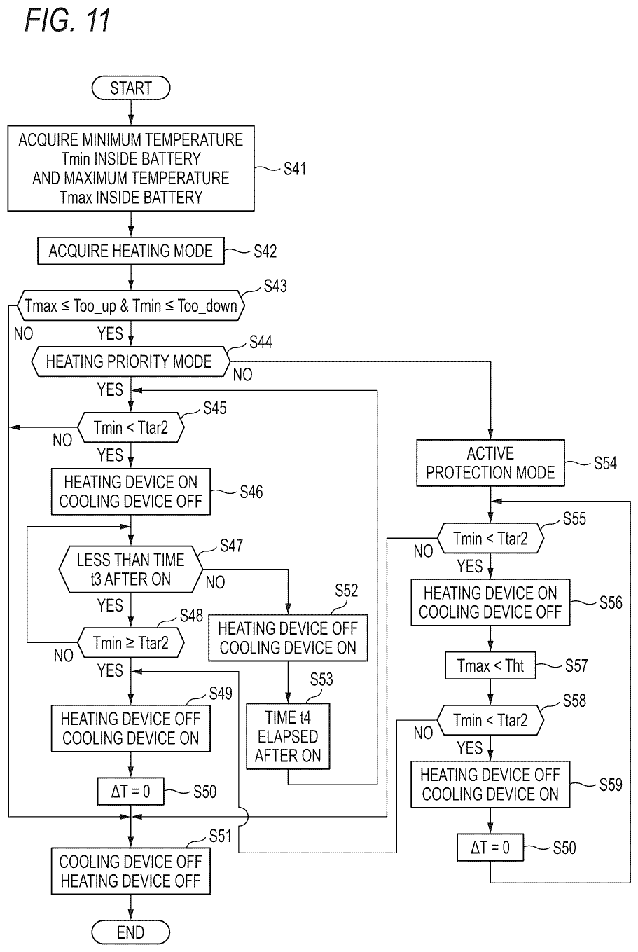

FIG. 11 is a flowchart showing a procedure for executing the heating mode described in FIG. 10. First, the battery ECU 6 acquires the minimum temperature Tmin inside the battery and the maximum temperature Tmax inside the battery (step S41). Subsequently, the heating mode set in response to the operation of the user interface 9 by the user is acquired (step S42).

Next, the temperature control unit 7 compares the following four values.
Minimum temperature Tmin inside the battery
Maximum temperature Tmax inside the battery
Heating device operation permitted battery upper limit temperature Too_up at which the operation of the heating device 5 is permitted
Heating device operation permitted battery lower limit temperature Too_down at which the operation of the heating device 5 is permitted

The temperature control unit 7 determines whether the maximum temperature Tmax inside the battery is equal to or lower than the heating device operation permitted battery upper limit temperature Too_up and the minimum temperature Tmin inside the battery is equal to or lower than the heating device operation permitted battery lower limit temperature Too_down (step S43). That is, the temperature control unit 7 determines whether the following formula (2) is satisfied.

$$T max \leq Too\_up and T min \leq Too\_down \qquad ( 2 )$$

If the condition of the formula (2) is satisfied (step S43; Yes), the temperature control unit 7 determines whether the set heating mode is the heating priority mode shown in (a) of FIG. 10 (step S44). If the set heating mode is the heating priority mode (step S44; Yes), the temperature control unit 7 determines whether the minimum temperature Tmin inside the battery is lower than a heating target temperature Ttar2 which is a temperature to be targeted in the heating mode (step S45).

If the minimum temperature Tmin inside the battery is lower than the heating target temperature Ttar2 (Tmin<Ttar2) (step S45; Yes), the temperature control unit 7 sets the heating state in which the heating device 5 is turned on (the operating state) and the cooling device 4 is turned off (the non-operating state) (step S46).

After the heating device 5 is turned on, the temperature control unit 7 counts an operating time of the heating device 5 and determines whether the operating time is less than a heating device operating time t3 (step S47). If the operating time is less than the heating device operating time t3 (step S47; Yes), the temperature control unit 7 determines whether the minimum temperature Tmin inside the battery is equal to or higher than the heating target temperature Ttar2 (Tmin≥Ttar2) (step S48).

If the minimum temperature Tmin inside the battery is equal to or higher than the heating target temperature Ttar2 (step S48; Yes), the temperature control unit 7 sets the cooling state in which the heating device 5 is turned off (the non-operating state) and the cooling device 4 is turned on (the operating state) (step S49). In step S48, if the minimum temperature Tmin inside the battery is not equal to or higher than the heating target temperature Ttar2 (step S48; No), the process returns to step S47 again, and the temperature control unit 7 counts the operating time of the heating device 5.

If the temperature difference ΔT obtained by subtracting the battery upper portion temperature Tu from the battery lower portion temperature Td becomes zero (step S50), the temperature control unit 7 sets the stopped state in which the heating device 5 is turned off (the non-operating state) and the cooling device 4 is turned off (the non-operating state) (step S51), and ends the processing.

In step S47, if the operating time of the heating device 5 is not less than the heating device operating time t3 (Step S47; No), the temperature control unit 7 sets the cooling state in which the heating device 5 is turned off (the non-operating state) and the cooling device 4 is turned on (the operating state) (step S52).

After the cooling device 4 is turned on, when the operating time exceeds the cooling device operating time t4 (step S53), the process returns to step S45 again, and the processing subsequent to step S45 is repeated.

If the condition of the formula (2) is not satisfied in step S43 (step S43; No), or if the minimum temperature Tmin inside the battery is not lower than the heating target temperature Ttar2 in step S45 (step S45; No), the process proceeds to step S51, and the temperature control unit 7 sets the stopped state and ends the processing.

Next, the active protection mode shown in (b) of FIG. 10 will be described. If it is determined in step S44 that the set heating mode is not the heating priority mode (step S44; No), the temperature control unit 7 determines that the set heating mode is the active protection mode (step S54).

If the minimum temperature Tmin inside the battery is lower than the heating target temperature Ttar2 (Tmin<Ttar2) (step S55; Yes), the temperature control unit 7 sets the heating state in which the heating device 5 is turned on (the operating state) and the cooling device 4 is turned off (the non-operating state) (step S56).

When the maximum temperature Tmax inside the battery reaches the allowable upper limit temperature Tht during heating (Tmax=Tht) (step S57), the temperature control unit 7 determines whether the minimum temperature Tmin inside the battery is lower than the heating target temperature Ttar2 (step S58), and if the minimum temperature Tmin inside the battery is lower than the heating target temperature Ttar2 (Tmin<Ttar2) (step S58; Yes), the temperature control unit 7 sets the cooling state in which the heating device 5 is turned off (the non-operating state) and the cooling device 4 is turned on (the operating state) (step S59).

If the temperature difference ΔT obtained by subtracting the battery upper portion temperature Tu from the battery lower portion temperature Td becomes zero (step S60), the process returns to step S55 again, and the processing subsequent to step S55 is repeated. However, if the minimum temperature Tmin inside the battery is not lower than the heating target temperature Ttar2 in step S55 (step S55; No), the temperature control unit 7 proceeds to step S51, and the temperature control unit 7 sets the stopped state and ends the processing. If the minimum temperature Tmin inside the battery is not lower than the heating target temperature Ttar2 in step S58 (step S58; No), the temperature control unit 7 proceeds to step S49 and performs the processing subsequent to step S49.

As described above, in the heating mode, when the minimum temperature Tmin inside the battery is lower than the heating target temperature Ttar2 (steps S45 and S55), the temperature control unit 7 sets the heating state (steps S46 and S56). Next, when the minimum temperature Tmin inside the battery is equal to or higher than the heating target temperature Ttar2 in the heating state (steps S48 and S58), the temperature control unit 7 switches from the heating state to the cooling state (steps S49 and S59). Further, when the temperature difference ΔT obtained by subtracting the battery upper portion temperature Tu from the battery lower portion temperature Td is equal to or smaller than the first predetermined value (ΔT=0 in this example) in the cooling state (step S50), the temperature control unit 7 switches from the cooling state to the stopped state (step S51).

In this way, by switching from the heating state to the cooling state when the minimum temperature Tmin inside the battery is equal to or higher than the heating target temperature Ttar2 during heating of the battery 3, overheating of a higher temperature region can be prevented.

In the heating priority mode shown in (a) of FIG. 10, when the operating state of the heating device 5 exceeds the heating device operating time t3 before the minimum temperature Tmin inside the battery becomes equal to or higher than the heating target temperature Ttar2 in the heating state (step S47), the temperature control unit 7 switches from the heating state to the cooling state (step S52), and when the operating state of the cooling device 4 exceeds the cooling device operating time t4 in the cooling state (step S53), the temperature control unit 7 switches from the cooling state to the heating state (step S46).

Accordingly, it is possible to make the minimum temperature Tmin inside the battery to reach the heating target temperature Ttar2 over an appropriate time while preventing the overheating of the higher temperature region.

In the active protection mode shown in (b) of FIG. 10, when the maximum temperature Tmax inside the battery reaches the allowable upper limit temperature Tht during heating before the minimum temperature Tmin inside the battery becomes equal to or higher than the heating target temperature Ttar2 in the heating state (step S57), the temperature control unit 7 switches from the heating state to the cooling state (step S59), and when the temperature difference ΔT obtained by subtracting the battery upper portion temperature Tu from the battery lower portion temperature Td in the cooling state is equal to or smaller than the first predetermined value (ΔT=0 in this example) (step S60), the temperature control unit 7 switches from the cooling state to the heating state (step S56).

Accordingly, the minimum temperature Tmin inside the battery can reach the heating target temperature Ttar2 while preventing the maximum temperature Tmax inside the battery from exceeding the allowable upper limit temperature Tht during heating, and deterioration of the battery 3 can be prevented.

Although the various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiment may be freely combined without departing from the gist of the invention.

For example, the battery 3 is not limited to the laminated cell, and may be a can-type cell or a cylindrical cell.

In the present specification, at least the following matters are described. Although corresponding constituent elements or the like in the embodiment described above are shown in parentheses, the present invention is not limited thereto.
(1) A battery temperature control system (battery temperature control system 1) including:
a battery (battery 3);
a cooling unit (cooling device 4) configured to cool the battery;
a heating unit (heating device 5) configured to heat the battery;
a temperature acquisition unit (battery ECU 6) configured to acquire a temperature of the battery; and
a temperature control unit (temperature control unit 7) configured to control the cooling unit and the heating unit, in which
the temperature control unit is configured to be capable of switching between
   a cooling state in which the cooling unit is in an operating state and the heating unit is in a non-operating state,
   a heating state in which the cooling unit is in the non-operating state and the heating unit is in the operating state, and
   a stopped state in which the cooling unit is in the non-operating state and the heating unit is in the non-operating state, and
the temperature control unit is configured to switch between the cooling state and the heating state at least once when the temperature of the battery approaches a target temperature (cooling target temperature Ttar1 and heating target temperature Ttar2).

According to (1), it is possible to bring the temperature of the battery close to the target temperature while eliminating a temperature difference inside the battery. Accordingly, it is possible to prevent the output of the battery from being limited due to a localized decrease in the temperature of the battery, or prevent the battery from deteriorating due to a localized increase in the temperature of the battery.
(2) The battery temperature control system according to (1), in which
the temperature control unit continuously switches between the cooling state and the heating state a plurality of times.

According to (2), it is possible to more reliably prevent an increase in the temperature difference inside the battery.
(3) The battery temperature control system according to (1), further including:
an output control unit (battery ECU 6) configured to control an output of the battery, in which
the temperature acquisition unit acquires temperatures of a plurality of locations in the battery, and
the output control unit controls the output of the battery based on a lower-temperature side temperature (minimum temperature Tmin inside the battery) among the temperatures of the plurality of locations.

According to (3), in an environment in which the output of the battery is controlled based on the lower-temperature side temperature of the battery, by bringing the temperature of the battery close to the target temperature while eliminating the temperature difference inside the battery, it is possible to prevent the temperature of the battery from being locally decreased and the output of the battery from being limited.
(4) The battery temperature control system according to (1), in which
the temperature acquisition unit acquires temperatures of a plurality of locations in the battery, and
switching between the cooling state and the heating state is performed based on a temperature difference (temperature difference ΔT) between a higher-temperature side temperature and a lower-temperature side temperature.

According to (4), it is possible to prevent the temperature difference between the higher-temperature side temperature and the lower-temperature side temperature of the battery from increasing by a predetermined value or more.
(5) The battery temperature control system according to (1), in which
switching between the cooling state and the heating state is performed based on an operation time of the cooling unit or the heating unit.

According to (5), it is possible to prevent the temperature difference between the higher-temperature side temperature and the lower-temperature side temperature of the battery from increasing by a predetermined value or more, and to facilitate the control.
(6) The battery temperature control system according to (1), in which

the temperature control unit is configured to be able to control the temperature of the battery in a plurality of modes in which switching conditions between the cooling state and the heating state are different, and
the plurality of modes are set in response to a user request.

According to (6), the user request can be reflected in the temperature control of the battery.
(7) The battery temperature control system according to (1), in which
the temperature acquisition unit acquires temperatures of a plurality of locations of the battery, and
the temperature control unit
sets the cooling state when a higher-temperature side temperature (maximum temperature Tmax inside the battery) is higher than the target temperature (cooling target temperature Ttar1),
switches from the cooling state to the heating state when the higher-temperature side temperature is equal to or lower than the target temperature in the cooling state, and
switches from the heating state to the stopped state when a temperature difference (temperature difference ΔT) between the higher-temperature side temperature and a lower-temperature side temperature is equal to or smaller than a first predetermined value (ΔT=0) in the heating state.

According to (7), by switching from the cooling state to the heating state when the higher-temperature side temperature is equal to or lower than the target temperature during cooling of the battery, it is possible to prevent supercooling of a lower temperature region and prevent the output of the battery from being limited.
(8) The battery temperature control system according to (7), in which
the cooling state is switched to the heating state when an operating state of the cooling unit exceeds a first time (cooling device operating time t1) before the higher-temperature side temperature becomes to be equal to or lower than the target temperature in the cooling state, and
the heating state is switched to the cooling state when the temperature difference between the higher-temperature side temperature and the lower-temperature side temperature is equal to or smaller than the first predetermined value (ΔT=0) in the heating state.

According to (8), the temperature of the battery can reach the target temperature in a short time.

(9) The battery temperature control system according to (7), in which
the cooling state is switched to the heating state when an operating state of the cooling unit exceeds a first time (cooling device operating time t1) before the higher-temperature side temperature becomes to be equal to or lower than the target temperature in the cooling state, and
the heating state is switched to the cooling state when an operating state of the heating unit exceeds a second time (heating device operating time t2) in the heating state.

According to (9), it is possible to make the temperature of the battery to reach the target temperature over an appropriate time, and prevent the output of the battery from being limited.
(10) The battery temperature control system according to (7), in which
the cooling state is switched to the heating state when the temperature difference between the lower-temperature side temperature and the higher-temperature side temperature is equal to or smaller than a second predetermined value (ΔT=T1) in the cooling state, and
the heating state is switched to the cooling state when the temperature difference between the higher-temperature side temperature and the lower-temperature side temperature is equal to or smaller than the first predetermined value (ΔT=0) smaller than the second predetermined value in the heating state.

According to (10), the temperature of the battery can reach the target temperature while reducing a region where the output of the battery is limited.
(11) The battery temperature control system according to (7), in which
the temperature acquisition unit acquires temperatures of a plurality of locations in the battery, and
the temperature control unit
sets the heating state when the lower-temperature side temperature (minimum temperature Tmin inside the battery) is lower than the target temperature (heating target temperature Ttar2),
switches from the heating state to the cooling state when the lower-temperature side temperature is equal to or higher than the target temperature in the heating state, and
switches from the cooling state to the stopped state when the temperature difference between the higher-temperature side temperature and the lower-temperature side temperature is equal to or smaller than the first predetermined value (ΔT=0) in the cooling state.

According to (11), by switching from the heating state to the cooling state when the lower-temperature side temperature is equal to or higher than the target temperature during heating of the battery, overheating of a higher temperature region can be prevented.
(12) The battery temperature control system according to (11), in which
the heating state is switched to the cooling state when the operating state of the heating unit exceeds a third time (heating device operating time t3) before the lower-temperature side temperature becomes to be equal to or higher than the target temperature in the heating state, and
the cooling state is switched to the heating state when the operating state of the cooling unit exceeds a fourth time (cooling device operating time t4) in the cooling state.

According to (12), it is possible to make the temperature of the battery to reach the target temperature over an appropriate time while preventing overheating of the higher temperature region.
(13) The battery temperature control system according to (11), in which
the heating state is switched to the cooling state when the higher-temperature side temperature reaches an allowable upper limit temperature during heating (allowable upper limit temperature during heating Tht) before the lower-temperature side temperature becomes to be equal to or higher than the target temperature in the heating state, and the cooling state is switched to the heating state when the temperature difference between the higher-temperature side temperature and the lower-temperature side temperature is equal to or smaller than the first predetermined value (ΔT=0) in the cooling state.

According to (13), the temperature of the battery can reach the target temperature while preventing the temperature of the battery from exceeding the allowable upper limit temperature during heating, and deterioration of the battery can be prevented.
(14) The battery temperature control system according to any one of (1) to (13), further including:
a temperature control circuit (temperature control circuit 12) configured to connect the cooling unit, the heating unit, and a water jacket (water jacket 11) in direct or indirect contact with one surface of the battery and allow a heat transfer medium to circulate therethrough, in which
the temperature acquisition unit acquires a temperature of the one surface of the battery and a temperature of a side opposite to the one surface.

According to (14), since the one surface of the battery with which the water jacket is in direct or indirect contact is greatly affected by the temperature control circuit, the temperature of the battery can be appropriately managed by acquiring the temperature of the one surface of the battery and the temperature of the side opposite to the one surface.

### REFERENCE SIGNS LIST

1 battery temperature control system
2 control unit
3 battery
4 cooling device (cooling unit)
5 heating device (heating unit)
6 battery ECU (temperature acquisition unit, output control unit)
7 temperature control unit
8 EWP
9 user interface
11 water jacket
12 temperature control circuit
31 battery lower region
32 battery upper region

What is claimed is:

1. A battery temperature control system comprising:
a battery;
a cooling unit configured to cool the battery;
a heating unit configured to heat the battery;
a temperature acquisition unit configured to acquire a temperature of the battery; and
a temperature control unit configured to control the cooling unit and the heating unit, wherein
the temperature control unit is configured to be capable of switching between
a cooling state in which the cooling unit is in an operating state and the heating unit is in a non-operating state,
a heating state in which the cooling unit is in the non-operating state and the heating unit is in the operating state, and
a stopped state in which the cooling unit is in the non-operating state and the heating unit is in the non-operating state, and
the temperature control unit is configured to switch between the cooling state and the heating state at least once when the temperature of the battery approaches a target temperature.

2. The battery temperature control system according to claim 1, wherein
the temperature control unit is configured to continuously switch between the cooling state and the heating state a plurality of times.

3. The battery temperature control system according to claim 1, further comprising:
an output control unit configured to control an output of the battery, wherein
the temperature acquisition unit acquires temperatures of a plurality of locations in the battery, and
the output control unit controls the output of the battery based on a lower-temperature side temperature among the temperatures of the plurality of locations.

4. The battery temperature control system according to claim 1, wherein
the temperature acquisition unit acquires temperatures of a plurality of locations in the battery, and
switching between the cooling state and the heating state is performed based on a temperature difference between a higher-temperature side temperature and a lower-temperature side temperature.

5. The battery temperature control system according to claim 1, wherein
switching between the cooling state and the heating state is performed based on an operation time of the cooling unit or the heating unit.

6. The battery temperature control system according to claim 1, wherein
the temperature control unit is configured to be capable of controlling the temperature of the battery in a plurality of modes in which switching conditions between the cooling state and the heating state are different, and
the plurality of modes are set in response to a user request.

7. The battery temperature control system according to claim 1, wherein
the temperature acquisition unit acquires temperatures of a plurality of locations in the battery, and
the temperature control unit
sets the cooling state in a case where a higher-temperature side temperature is higher than the target temperature,
switches from the cooling state to the heating state in a case where the higher-temperature side temperature is equal to or lower than the target temperature in the cooling state, and
switches from the heating state to the stopped state in a case where a temperature difference between the higher-temperature side temperature and a lower-temperature side temperature is equal to or smaller than a first predetermined value in the heating state.

8. The battery temperature control system according to claim 7, wherein
the cooling state is switched to the heating state in a case where an operating state of the cooling unit exceeds a first time before the higher-temperature side temperature becomes to be equal to or lower than the target temperature in the cooling state, and
the heating state is switched to the cooling state in a case where the temperature difference between the higher-temperature side temperature and the lower-temperature side temperature is equal to or smaller than the first predetermined value in the heating state.

9. The battery temperature control system according to claim 7, wherein
the cooling state is switched to the heating state in a case where an operating state of the cooling unit exceeds a first time before the higher-temperature side temperature becomes to be equal to or lower than the target temperature in the cooling state, and
the heating state is switched to the cooling state in a case where an operating state of the heating unit exceeds a second time in the heating state.

10. The battery temperature control system according to claim 7, wherein
the cooling state is switched to the heating state in a case where the temperature difference between the lower-temperature side temperature and the higher-temperature side temperature is equal to or smaller than a second predetermined value in the cooling state, and
the heating state is switched to the cooling state in a case where the temperature difference between the higher-temperature side temperature and the lower-temperature side temperature is equal to or smaller than the first predetermined value smaller than the second predetermined value in the heating state.

11. The battery temperature control system according to claim 7, wherein
the temperature acquisition unit acquires temperatures of a plurality of locations in the battery, and
the temperature control unit
sets the heating state in a case where the lower-temperature side temperature is lower than the target temperature,
switches from the heating state to the cooling state in a case where the lower-temperature side temperature is equal to or higher than the target temperature in the heating state, and
switches from the cooling state to the stopped state in a case where the temperature difference between the higher-temperature side temperature and the lower-temperature side temperature is equal to or smaller than the first predetermined value in the cooling state.

12. The battery temperature control system according to claim 11, wherein
the heating state is switched to the cooling state in a case where the operating state of the heating unit exceeds a third time before the lower-temperature side temperature becomes to be equal to or higher than the target temperature in the heating state, and
the cooling state is switched to the heating state in a case where the operating state of the cooling unit exceeds a fourth time in the cooling state.

13. The battery temperature control system according to claim 11, wherein
the heating state is switched to the cooling state in a case where the higher-temperature side temperature reaches an allowable upper limit temperature during heating before the lower-temperature side temperature becomes to be equal to or higher than the target temperature in the heating state, and
the cooling state is switched to the heating state in a case where the temperature difference between the higher-temperature side temperature and the lower-temperature side temperature is equal to or smaller than the first predetermined value in the cooling state.

14. The battery temperature control system according to claim 1, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.

15. The battery temperature control system according to claim 2, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.

16. The battery temperature control system according to claim 3, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.

17. The battery temperature control system according to claim 4, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.

18. The battery temperature control system according to claim 5, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.

19. The battery temperature control system according to claim 6, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.

20. The battery temperature control system according to claim 7, further comprising:
a temperature control circuit configured to connect the cooling unit, the heating unit and a water jacket in direct or indirect contact with one surface of the battery and allow a heat transfer medium to circulate therethrough, wherein
the temperature acquisition unit acquires a temperature of a side of the one surface of the battery and a temperature of a side of the battery opposite to the one surface.
